(19) United States
(12) Patent Application Publication
(10) Pub. No.: US 2026/0267251 A1
(43) Pub. Date: Sep. 10, 2026

(54) IMAGE FORMING APPARATUS

(71) Applicant: CANON KABUSHIKI KAISHA, Tokyo (JP)

(72) Inventors: TAKASHI MUKAI, Kanagawa (JP); YUSUKE SHIMIZU, Kanagawa (JP)

(21) Appl. No.: 19/552,346

(22) Filed: Feb. 27, 2026

(30) Foreign Application Priority Data
Mar. 4, 2025 (JP) 2025-034133

(51) Int. Cl. G03G 15/01; G03G 15/00

(52) U.S. Cl. CPC G03G 15/0173; G03G 15/011; G03G 15/50

(57) ABSTRACT

An image forming apparatus includes a developing device and a correction unit. The developing device includes a development roller configured to form a developer image on a photosensitive drum, a development chamber configured to accommodate the developer to be supplied to the development roller, and an opening configured to receive the developer to be supplied to the development chamber. The correction unit is configured to correct latent image forming conditions for the electrostatic latent image in a case where the developer is supplied through the opening. An amount of change in latent image forming conditions that is corrected with respect to an opening region by the correction unit is larger than an amount of change in latent image forming conditions that is corrected with respect to a non-opening region.

### BACKGROUND

### Field of the Technology

The present disclosure relates to an electrophotographic image forming apparatus that forms an image on a recording material.

### Description of the Related Art

A conventional electrophotographic image forming apparatus includes an exposure device that exposes a surface of a photosensitive drum to light to form an electrostatic latent image, a developing device that includes a development roller and develops the electrostatic latent image, and a detachable supply container that supplies toner to the developing device.

Such an image forming apparatus performs gamma correction processing in order to match a target print image density with a density of an image to be actually printed. The gamma correction processing corrects gamma characteristics (input/output characteristics). The gamma characteristics change due to degradation of the photosensitive drum and environmental changes such as changes in temperature and humidity. Accordingly, the gamma correction processing is performed periodically or at a timing when it is detected that a change in condition exceeds a threshold.

An image forming apparatus may cause density unevenness within a recording surface due to distortion resulting from manufacturing errors and assembly errors of constituent components, support members, and the like, even when forming an image with uniform gradation. Such density unevenness can reduce calibration accuracy of the gamma correction processing.

Japanese Patent Laid-Open No. 2007-57954 describes a technique of performing gamma correction processing for a plurality of positions in a main scanning direction in order to improve density unevenness. Japanese Patent Laid-Open No. 2013-44990 describes a technique of forming toner patches for detecting density unevenness at a plurality of positions in the main scanning direction of a scanner and performing gamma correction processing based on density detection results of the toner patches, thereby reducing density unevenness.

In a conventional image forming apparatus, in a configuration in which an opening for supplying toner to the developing device is located in a part of a rotational axis direction (a longitudinal direction) of the development roller, density unevenness may occur before and after toner supply.

### SUMMARY

The present disclosure is directed to reducing density unevenness due to toner supply with a simple configuration.

According to an aspect of the present disclosure, an image forming apparatus includes a photosensitive drum, an exposure device configured to expose a surface of the photosensitive drum to light to form an electrostatic latent image on the photosensitive drum, a developing device including a development roller configured to supply developer to the electrostatic latent image formed on the photosensitive drum to form a developer image on the photosensitive drum, a development chamber configured to accommodate the developer to be supplied to the development roller, and an opening configured to receive the developer to be supplied to the development chamber, and a correction unit configured to, in a case where the developer is supplied to the development chamber through the opening, correct, for each of a plurality of divided regions into which an image forming region where the developer image is formable is divided in a rotational axis direction of the development roller, a latent image forming condition used by the exposure device to form the electrostatic latent image, wherein the opening is disposed at a position overlapping the image forming region in the rotational axis direction, and wherein, with respect to the plurality of divided regions into which the image forming region is divided in the rotational axis direction, when a divided region overlapping the opening in the rotational axis direction is defined as an opening region and a divided region not overlapping the opening in the rotational axis direction is defined as a non-opening region, an amount of change in the latent image forming condition that is corrected for the opening region by the correction unit is larger than an amount of change in the latent image forming condition that is corrected for the non-opening region by the correction unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view illustrating a schematic configuration of an image forming apparatus.

FIGS. 2A to 2D are a schematic sectional view of a rotary main body and peripheral members.

FIGS. 3A and 3B are schematic sectional views illustrating a state where a toner cartridge is attached to and detached from the rotary main body.

FIG. 4 is a schematic sectional view illustrating a schematic configuration of a development unit and a toner cartridge.

FIGS. 5A and 5B are schematic views illustrating positions in a longitudinal direction of a receiving opening and a discharge opening.

FIGS. 6A to 6E are schematic views each illustrating positions (orientations) of the development unit and the toner cartridge during a toner supply operation.

FIG. 7 is a schematic sectional view illustrating a toner supply path.

FIG. 8 is an electrical block diagram illustrating an exposure control configuration.

FIG. 9 is a functional block diagram illustrating image processing.

FIGS. 10A to 10C are graphs each illustrating a gradation correction method.

FIG. 11 is a graph illustrating density unevenness in the longitudinal direction.

FIG. 12 is a flowchart illustrating processing of controlling latent image forming conditions according to an embodiment.

FIGS. 13A to 13C are graphs each illustrating gamma correction for each longitudinal position before and after toner supply in Example 1.

FIGS. 14A to 14C are graphs each illustrating gamma correction for opening longitudinal positions with different numbers of printed sheets after toner supply in Example 1.

### DESCRIPTION OF THE EMBODIMENTS

Embodiments of the present disclosure will be illustratively described in detail below with reference to the drawings.

The dimensions, materials, shapes, relative arrangements, and the like of the components described in the following embodiments should be modified as appropriate depending on the configuration of an apparatus to which the present disclosure is applied and various conditions.

In other words, the scope of the present disclosure is not meant to be limited to the following embodiments.

### First Embodiment

An image forming apparatus 1 according to a first embodiment will be described. In the following description and the drawings, a vertical direction when the image forming apparatus 1 is placed on a horizontal surface is defined as a Z-direction. A direction that is perpendicular to the Z-direction and extending along a rotational axis 90C of a rotary main body 90 to be described below (rotational axis direction of the rotary main body) is defined as a Y-direction. A direction that is perpendicular to each of the Z-direction and the Y-direction is defined as an X-direction. A direction indicated by an arrow X, a direction indicated by an arrow Y, and a direction indicated by an arrow Z in the drawings represent a +X-side, a +Y-side, and a +Z-side, respectively, and the sides opposite to the +X-side, the +Y-side, and the +Z-side are represented as a −X-side, a −Y-side, and a −Z-side, respectively, as needed.

### <Overall Configuration of Image Forming Apparatus>

An overall configuration of the image forming apparatus 1 will now be described. The image forming apparatus 1 is a laser printer that forms an image on each sheet S by an electrophotographic method. More specifically, the image forming apparatus 1 is a rotary development type color laser printer including the rotary main body 90 that includes four development units 50y, 50m, 50c, and 50k. Suffix letters added to the development units 50y, 50m, 50c, and 50k represent the respective colors of toner. “y” represents yellow, “m” represents magenta, “c” represents cyan, and “k” represents black. A full-color image is formed by forming color images in a superimposed manner.

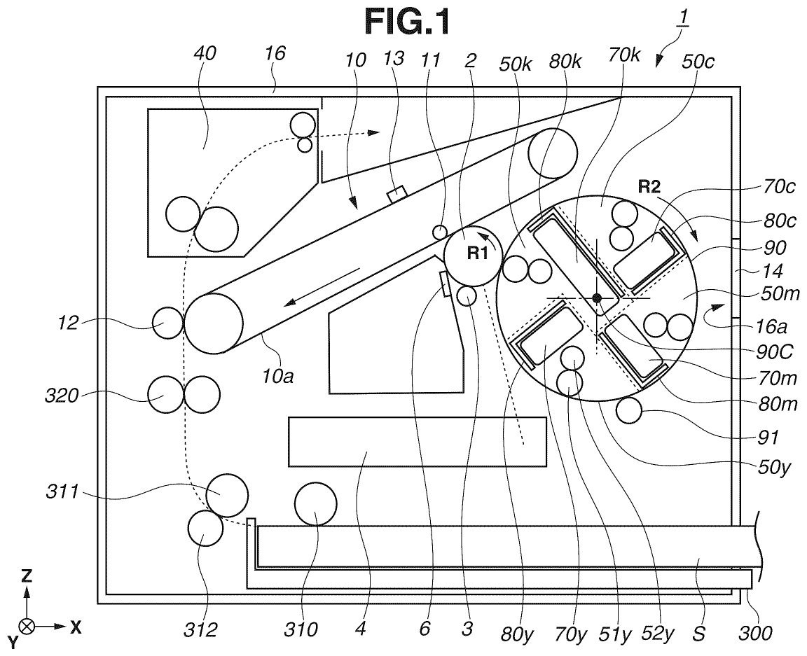

A schematic configuration and an image forming operation of the image forming apparatus 1 will be described with reference to FIG. 1. FIG. 1 is a schematic sectional view illustrating a sectional configuration of the image forming apparatus 1.

The image forming apparatus 1 includes an image forming apparatus body and toner cartridges 70y, 70m, 70c, and 70k that are detachably attached to the image forming apparatus body. The image forming apparatus 1 includes a drum-shaped (cylindrical) photosensitive drum 2 as an image carrying member on which an electrostatic latent image is formed and which carries toner as developer. A charging roller 3 serving as a charging unit, a scanner 4 serving as an exposure unit, and a photosensitive drum cleaning unit 6 serving as a cleaning unit are arranged in the vicinity of the photosensitive drum 2. The scanner 4 irradiates the surface of the photosensitive drum 2, which is uniformly charged by the charging roller 3, with laser light based on image information, thus forming an electrostatic latent image.

The image forming apparatus 1 includes the development units 50y, 50m, 50c, and 50k that develop (visualize) the electrostatic latent image formed on the surface of the photosensitive drum 2 into a developer image (toner image) with toner of the corresponding color. The development units 50y, 50m, 50c, and 50k develop the electrostatic latent images formed on the surface of the photosensitive drum 2 with yellow toner, magenta toner, cyan toner, and black toner, respectively. The development unit 50y includes a development roller 51y and a supply roller 52y. The development roller 51y is a developer carrying member that rotates while carrying toner as developer to be supplied onto the photosensitive drum 2. The rotational axis direction (longitudinal direction) of the development roller 51y corresponds to the Y-direction. The supply roller 52y is a supply member that is located in contact with the development roller 51y and supplies toner to the development roller 51y. The other development units 50m, 50c, and 50k include development rollers 51m, 51c, and 51k and supply rollers 52m, 52c, and 52k, respectively. The image forming apparatus 1 further includes a sheet accommodating portion 300, a pickup roller 310, a feed roller 311, a separation roller 312, a conveyance roller pair 320, a secondary transfer roller 12, a fixing device 40, and an intermediate transfer unit 10. The pickup roller 310 is a feed unit that feeds the sheets S. The feed roller 311 and the separation roller 312 are a separation/conveyance unit that conveys the sheets S one by one while separating the sheets S by a frictional force. The secondary transfer roller 12 is a transfer unit that transfers images onto each sheet S from an intermediate transfer belt 10a.

### <Rotary Configuration>

A configuration example of the rotary main body 90 will be described with reference to FIGS. 1 to 5B. As illustrated in FIG. 1, the rotary main body 90 includes the development units 50y, 50m, 50c, and 50k. The toner cartridges 70y, 70m, 70c, and 70k corresponding to the development units 50y, 50m, 50c, and 50k, respectively, are attached to the rotary main body 90. The toner cartridges 70y, 70m, 70c, and 70k accommodate yellow toner, magenta toner, cyan toner, and black toner, respectively, as toner to be supplied to the development units 50y, 50m, 50c, and 50k. Trays 80y, 80m, 80c, and 80k in which the toner cartridges 70y, 70m, 70c, and 70k are detachably held, respectively, are attached to the rotary main body 90. An operation for attaching and detaching each toner cartridge 70 to and from the corresponding tray 80 will be described below.

The rotary main body 90 is rotatable about the rotational axis 90C extending in a Y-axis direction. The rotary main body 90 rotates about the rotational axis 90C, thus allowing any one of the development rollers 51y, 51m, 51c, and 51k to face the photosensitive drum 2. The rotary main body 90 is swingably supported about a pivot shaft 91 and is constantly biased counterclockwise so that the development roller 51 can contact the photosensitive drum 2. This allows the development roller 51 to contact the photosensitive drum 2, thereby forming a development nip.

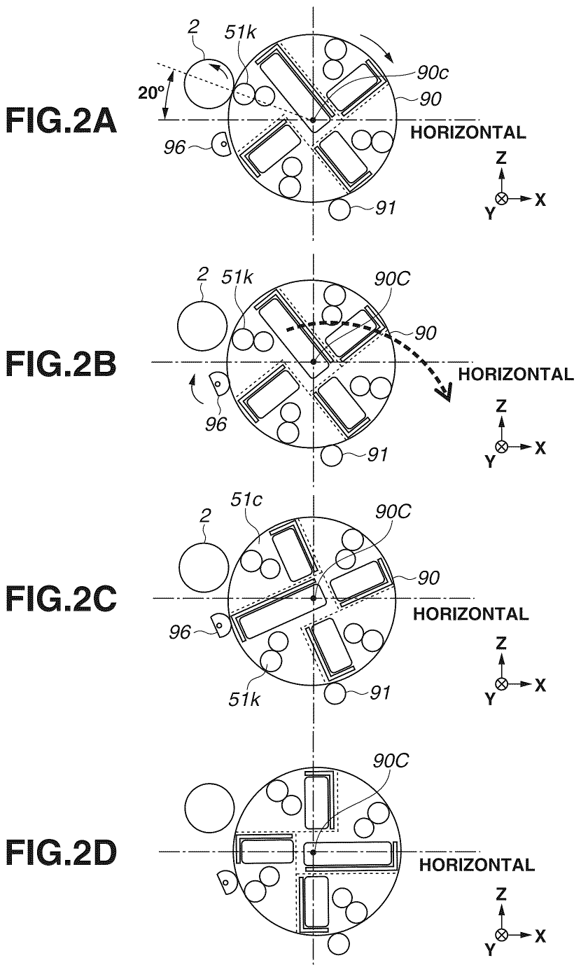

FIGS. 2A to 2D are schematic sectional views each illustrating the rotary main body 90 and peripheral members, and also illustrate a state where the photosensitive drum 2 and the development roller 51k are in contact with each other or are separated from each other. FIG. 2A illustrates a black development position (orientation) in which the development roller 51k is in contact with the photosensitive drum 2 to form the development nip. A position in which the development roller 51y faces the photosensitive drum 2 is referred to as a yellow development position. A position in which the development roller 51m faces the photosensitive drum 2 is referred to as a magenta development position. A position in which the development roller 51c faces the photosensitive drum 2 is referred to as a cyan development position. The rotary main body 90 can also take a separated state where the development rollers 51y, 51m, 51c, and 51k are not in contact with the photosensitive drum 2. As illustrated in FIG. 2B, a cam 96 is rotated to contact a frame of the rotary main body 90, and the rotary main body 90 is rotated in a clockwise direction indicated by a dotted-line arrow about the pivot shaft 91, thereby separating the photosensitive drum 2 and the development roller 51k from each other.

During a period in which the rotary main body 90 waits for execution of the image forming operation, the rotary main body 90 takes a standby position (orientation) in which the photosensitive drum 2 is located in a space between the development roller 51c and the development roller 51k in a state where the photosensitive drum 2 is separated from the development rollers 51 as illustrated in FIG. 2C.

When a user replaces the toner cartridge 70, the rotary main body 90 takes a replacement position (orientation). FIG. 2D illustrates the replacement position of the black toner cartridge 70k. In the replacement position of the black toner cartridge 70k, the black toner cartridge 70k is oriented parallel to a horizontal line.

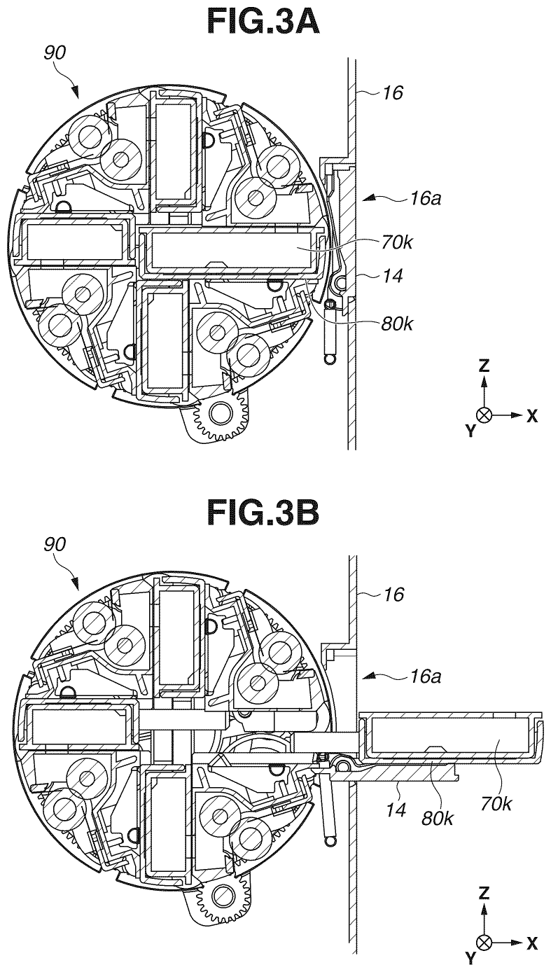

The attachment and detachment of the toner cartridge 70k to and from the rotary main body 90 will be described with reference to FIGS. 3A and 3B. The image forming apparatus 1 includes an opening 16a formed in a +X-side side wall 16 of the main body of the image forming apparatus 1. FIG. 3A illustrates a state where the toner cartridge 70k is stopped at the replacement position of the black toner cartridge 70k of the rotary main body 90, which is a position at which the toner cartridge 70k faces the opening 16a and a door 14, and is supported by the tray 80k. This state is referred to as an attachment position of the toner cartridge 70. FIG. 3B illustrates a state where the door 14 is opened from the state illustrated in FIG. 3A and the tray 80k has moved in a sliding manner to the outside of the rotary main body 90 through the opening 16a. In the state illustrated in FIG. 3B, the toner cartridge 70k can be attached to or detached from the rotary main body 90, so that the user can replace the toner cartridge 70k. This state is referred to as a retracted position of the toner cartridge 70.

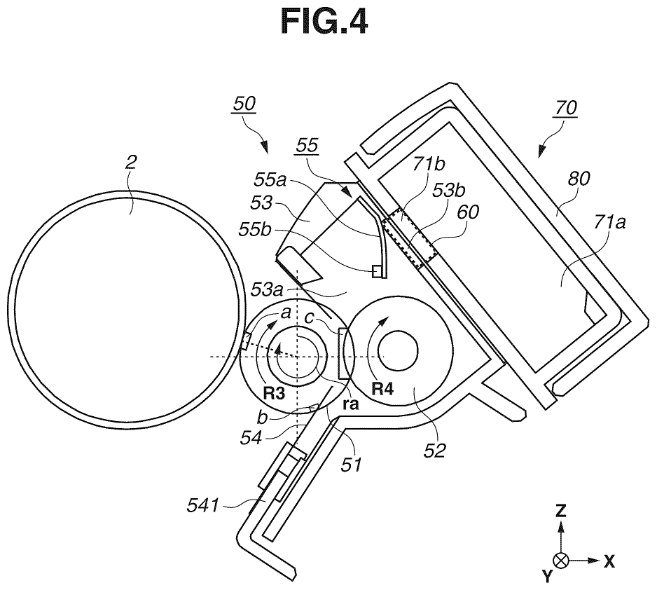

FIG. 4 is a schematic sectional view illustrating the development unit 50, the toner cartridge 70, and the tray 80 according to the present embodiment.

The toner cartridge 70 includes a toner frame 71. The toner frame 71 includes a toner accommodating portion 71a to accommodate toner, and one or more discharge openings 71b that communicate with the toner accommodating portion 71a in the longitudinal direction.

Each development unit 50 includes a development frame 53. The development frame 53 includes a developing-side accommodating portion 53a serving as a development chamber, and a receiving opening 53b serving as an opening that communicates with the developing-side accommodating portion 53a.

The toner cartridge 70 is movable between the attachment position and the retracted position where the toner cartridge 70 is retracted from the attachment position with respect to the development frame 53. In a state where the toner cartridge 70 is attached to the development frame 53, the discharge opening 71b faces the receiving opening 53b. In other words, the toner accommodating portion 71a of the toner cartridge 70 and the developing-side accommodating portion 53a of the respective development units 50 communicate with each other through a communicating portion 60 (portion indicated by a dotted line) including the discharge opening 71b and the receiving opening 53b. As described in detail below, when toner is supplied from the toner cartridge 70 to the development unit 50, the communicating portion 60 is oriented downward in the vertical direction (−Z direction) relative to the horizontal direction.

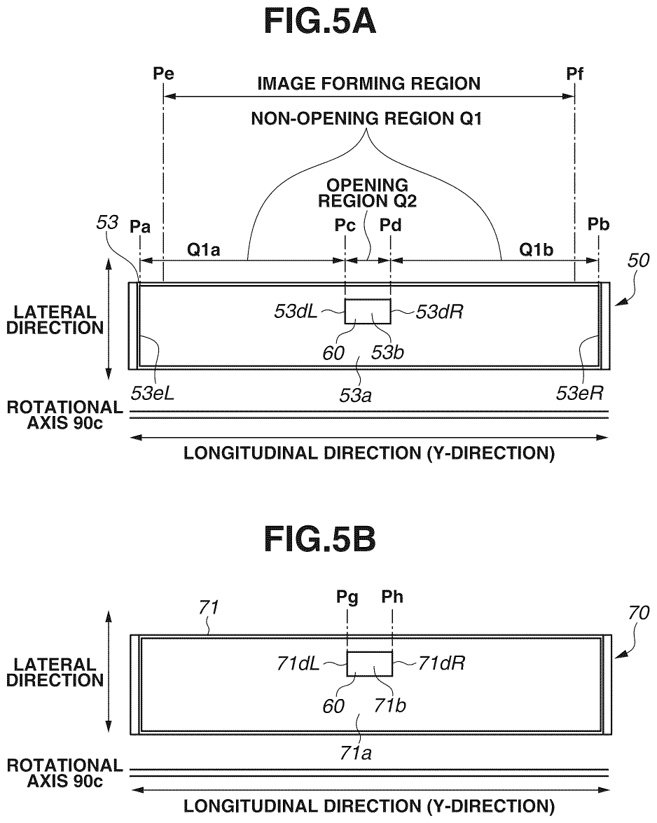

FIG. 5A illustrates the position the receiving opening 53b of a development unit 50 in the Y-direction. FIG. 5B illustrates the position of the discharge opening 71b of the toner cartridge 70 in the Y-direction. In the Y-direction corresponding to the rotational axis direction of the development roller 51, a non-opening region Q1 where the receiving opening 53b is not located and an opening region Q2 where the receiving opening 53b is located are provided. The non-opening region Q1 and the opening region Q2 are examples of regions into which an image forming region on which a toner image can be formed on the surface of the photosensitive drum 2 are partitioned (divided) in the Y-direction. A non-opening region Q1a is formed between a left-side end 53eL (longitudinal position Pa) in the longitudinal direction of the developing-side accommodating portion 53a and a left-side end 53dL (longitudinal position Pc) of the receiving opening 53b. A non-opening region Q1b is formed between a right-side end 53eR (longitudinal position Pb) in the longitudinal direction of the developing-side accommodating portion 53a and a right-side end 53dR (longitudinal position Pd) of the receiving opening 53b. The non-opening region Q1, including the non-opening region Q1a and the non-opening region Q1b, includes a longitudinal position that overlaps the image forming region between a longitudinal position Pe and a longitudinal position Pf. The opening region Q2 is formed between the left-side end 53dL (longitudinal position Pc) and the right-side end 53dR (longitudinal position Pd) of the receiving opening 53b. The opening region Q2 is a region where the receiving opening 53b is located and is one of the partitioned (divided) regions of the image forming region on which toner images are formed on the surface of the photosensitive drum 2. Thus, the opening region Q2 is located so that the non-opening region Q1 where the receiving opening 53b is not located is present in the Y-direction corresponding to the rotational axis direction of the development roller 51.

In the first embodiment, the discharge opening 71b is also located at a longitudinal position corresponding to that of the receiving opening 53b. A longitudinal position Pg of a left-side end 71dL of the discharge opening 71b coincides with the longitudinal position Pc. A longitudinal position Ph of a right-side end 71dR of the discharge opening 71b coincides with the longitudinal position Pd. These longitudinal positions coincide with those of the communicating portion 60 to be described below.

The opening region Q2 where the receiving opening 53b is located indicates a region that communicates with the discharge opening 71b. In other words, the opening region Q2 indicates a region where new toner is supplied to the developing-side accommodating portion 53a in the direction perpendicular to the Y-direction from the discharge opening 71b through the receiving opening 53b. Accordingly, during toner supply, toner is supplied to the developing-side accommodating portion 53a from a part of the developing-side accommodating portion 53a in the region in the longitudinal direction through the receiving opening 53b. The non-opening region Q1 is supplied with new toner by new toner moving in the longitudinal direction from the opening region Q2.

In the toner supply configuration in which the non-opening region Q1 is present, density unevenness can occur due to toner supply as described below. While the present embodiment illustrates an example where one receiving opening 53b is arranged in the longitudinal direction, a plurality of receiving openings 53b may be arranged in the longitudinal direction. While the present embodiment illustrates an example where the receiving opening 53b is arranged within the image forming region, the receiving opening 53b may be arranged outside of the image forming region.

Each development unit 50 may include a backflow preventing member (sealing member) 55 that covers the receiving opening 53b so as to prevent toner in the developing-side accommodating portion 53a from flowing back to the toner accommodating portion 71a of the toner cartridge 70. The backflow preventing member 55 is configured to be opened or closed by being rotated about an axis at one end thereof under gravity acting on the backflow preventing member 55.

### <Image Forming Operation>

An image forming operation according to the present embodiment will be described. In response to receiving image information from an external apparatus (not illustrated) such as a host computer, the image forming apparatus 1 transmits a print signal to start the image forming operation. Initially, in the standby position, the photosensitive drum 2 is rotated in synchronization with the rotation of the intermediate transfer belt 10a and in a direction indicated by an arrow R1 (counterclockwise) illustrated in FIG. 1. The surface of the photosensitive drum 2 is uniformly charged by the charging roller 3.

In the case of forming a color image on the sheet S, the rotary main body 90 is rotated in a direction indicated by an arrow R2 (clockwise as viewed along the Y-axis direction) in FIG. 1 while supporting the development units 50y, 50m, 50c, and 50k. Subsequently, an electrophotographic process is repeatedly performed while the development rollers 51y, 51m, 51c, and 51k are moved one by one to the development position.

Initially, the scanner 4 irradiates the surface of the photosensitive drum 2 with laser light based on image data corresponding to a yellow image, thereby forming an electrostatic latent image corresponding to the yellow image on the surface of the photosensitive drum 2. In parallel with the formation of the electrostatic latent image, the rotation of the rotary main body 90 is controlled by a direct-current (DC) brush motor (not illustrated).

Initially, the rotary main body 90 is rotated clockwise about the rotational axis 90C from the standby position illustrated in FIG. 2C. Specifically, the rotary main body 90 swings counterclockwise about the pivot shaft 91 by the rotation of the cam 96, thereby bringing the development roller 51y into contact with the photosensitive drum 2.

The electrostatic latent image formed on the surface of the photosensitive drum 2 is developed with yellow toner in a state where the development roller 51y is in contact with the photosensitive drum 2.

In the present embodiment, the development rollers 51y, 51m, 51c, and 51k are each an elastic roller coated with rubber around a metal shaft. At the development position, the development rollers 51y, 51m, 51c, and 51k each develop the corresponding electrostatic latent image in contact with the photosensitive drum 2. In other words, a contact development method is employed for the image forming apparatus 1 according to the present embodiment.

When the yellow toner image is developed, the yellow toner image formed on the surface of the photosensitive drum 2 is primarily transferred onto the intermediate transfer belt 10a by a primary transfer roller 11 arranged inside the intermediate transfer belt 10a illustrated in FIG. 1.

After the electrostatic latent image formed on the surface of the photosensitive drum 2 is developed with yellow toner, the rotary main body 90 is caused to swing clockwise about the pivot shaft 91 again by the rotation of the cam 96. This allows the development roller 51y to be separated from the photosensitive drum 2, and the rotary main body 90 is rotated clockwise about the rotational axis 90C, thereby starting to move to the magenta development position.

In the present embodiment, the rotary main body 90 does not rotate during a contacting/separating operation between the development roller 51 and the photosensitive drum 2. In order to reduce an image forming time, the contacting/separating operation between the development roller 51 and the photosensitive drum 2 may be performed while rotating the rotary main body 90. However, in that case, in order to prevent vibrations caused by the contacting/separating operation between the development roller 51 and the photosensitive drum 2 from adversely affecting the image forming operation such as charging and exposure, it is necessary to ramp up and ramp down the rotary rotation speed more slowly than in a related-art configuration.

Thus, the rotary main body 90 is rotated every 90° to sequentially move the development rollers 51m, 51c, and 51k to the development position, thereby forming toner images of the respective colors. Specifically, after the yellow toner image is formed on the intermediate transfer belt 10a, the rotary main body 90 takes the magenta development position, so that a magenta toner image is formed on the intermediate transfer belt 10a. After the magenta toner image is formed on the intermediate transfer belt 10a, the rotary main body 90 takes the cyan development position, so that a cyan toner image is formed on the intermediate transfer belt 10a. After the cyan toner image is formed on the intermediate transfer belt 10a, the rotary main body 90 takes the black development position, so that a black toner image is formed on the intermediate transfer belt 10a. In a case where color images are continuously formed, after the black toner image is formed on the intermediate transfer belt 10a, the rotary main body 90 takes the yellow development position again to sequentially develop toner images of the respective colors. In a case where color images are not continuously formed, the rotary main body 90 returns to the standby position.

Subsequently, primary transfer is repeated so that the toner images of the four colors are superimposed on the intermediate transfer belt 10a, thus forming a color image on the intermediate transfer belt 10a. During a period in which a color image is formed on the intermediate transfer belt 10a, the secondary transfer roller 12 and a cleaning device 13 do not contact the intermediate transfer belt 10a. After a color image is formed on the intermediate transfer belt 10a, the secondary transfer roller 12 and the cleaning device 13 contact the intermediate transfer belt 10a and prepare for secondary transfer. On the other hand, the sheets S are fed by the pickup roller 310 from the sheet accommodating portion 300 provided in a lower portion of the image forming apparatus 1. The sheets S are sent to the conveyance roller pair 320 in a state where the sheets S are separated one by one by the feed roller 311 and the separation roller 312. The conveyance roller pair 320 conveys each fed sheet S to a transfer portion (secondary transfer portion), which is a nip between the intermediate transfer belt 10a and the secondary transfer roller 12. The color image formed on the intermediate transfer belt 10a is transferred (secondarily transferred) onto the surface of the conveyed sheet S.

The sheet S onto which a color image is transferred is conveyed to the fixing device 40. In the fixing device 40, the sheet S is heated and pressed, thereby fixing the image onto the sheet S. The sheet S that has passed through the fixing device 40 is discharged as a printout to the outside of the image forming apparatus 1.

On the other hand, to form a black monochrome image on the sheet S, the rotary main body 90 is rotated to move to the black development position from the standby position. In this state, an electrostatic latent image is formed on the surface of the photosensitive drum 2 by charging the surface of the photosensitive drum 2 and exposing the surface of the photosensitive drum 2 to light, and then the electrostatic latent image is developed with black toner by the development roller 51k located at the development position. In a case where a black monochromatic image is continuously formed, development is continued while the rotary main body 90 remains in the black development position. In a case where a black monochromatic image is not continuously formed, the rotary main body 90 is returned to the standby position. After the black toner image is primarily transferred onto the intermediate transfer belt 10a, the black toner image is secondarily transferred onto the sheet S. The subsequent processes are similar to those in the case of forming a color image.

### <Details of Development Unit>

Next, the development units 50 according to the present embodiment will be described in detail with reference to FIG. 4. FIG. 4 is a schematic sectional view illustrating a configuration example of each development unit 50 according to the present embodiment. The development units 50y, 50m, 50c, and 50k have a similar configuration, so that a representative development unit 50 (e.g., the development unit 50y) will be described below, and description of the other development units will be omitted as appropriate.

Each development unit 50 according to the present embodiment includes the development frame 53 as the frame of the development unit 50, the development roller 51, the supply roller 52, a development blade 54, and the backflow preventing member 55.

The development roller 51 has a multi-layer structure in which a conductive elastic layer, including a base layer and a surface layer over the base layer, is provided around a 6-mm-diameter metal core, which is formed of a metal such as aluminum, an aluminum alloy, or stainless steel, so that development roller 51 has an outer diameter of 10 mm. The base layer of the elastic layer is formed of rubber, such as butadiene-acrylonitrile rubber (NBR), ethylene-propylene-diene rubber (EPDM), silicone rubber, or urethane rubber, and the surface layer is formed of ether urethane, nylon, or the like. The materials and structure of the conductive elastic layer are not limited to those described above. For example, the base layer may be a foam (e.g., sponge), and the surface layer may be a rubber elastic layer. Alternatively, the conductive elastic layer may also have a single-layer configuration made only of a rubber elastic layer made of NBR, EPDM, urethane rubber, or the like. In a case where the development unit 50 is in the development position, a driving force from a motor (not illustrated) is transmitted to the development roller 51 to be driven, so that the development roller 51 contacts the photosensitive drum 2 in a development portion while being rotationally driven in a direction indicated by an arrow R3 illustrated in FIG. 4. In this case, an angle ra between the development portion a and the center of the development roller 51 is 285 degrees in the direction of the arrow R3, with the apex of the development roller 51 in the +Z direction being defined as 0 degrees. Interference amount regulating rollers (not illustrated) are provided at both ends in the longitudinal direction (axial direction) of the development roller 51. The interference amount regulating rollers are brought into contact with the photosensitive drum 2 so that the amount by which the development roller 51 intrudes into the surface of the photosensitive drum 2 can be set to a predetermined value.

Below the development roller 51, the development blade 54 serving as a toner regulating member is disposed in such a manner that the development blade 54 is supported by a retaining plate 541 and a portion in the vicinity of a tip end at a free-end side is in contact with an outer peripheral surface of the development roller 51. A portion (contact portion) of the development roller 51 that is in contact with the development blade 54 is referred to as a regulating portion b. In the regulating portion b, the development blade 54 regulates the thickness of toner on the development roller 51 and charges the toner by frictional sliding. The contact direction of the development blade 54 corresponds to a counter direction in which the tip end side is located upstream of the contact portion in the rotational direction of the development roller 51.

The development blade 54 is a thin metal plate having spring elasticity, such as a thin stainless-steel plate or a thin phosphor bronze plate, which is in contact with the surface of the development roller 51 under a predetermined line pressure. A blade bias is applied to the retaining plate 541, which is a support member for the development blade 54, by a voltage applying unit (not illustrated) so as to provide a predetermined potential difference between the development roller 51 and the development blade 54. When the toner is negatively charged toner, the blade bias is set so that the development blade 54 is biased toward the negative polarity side relative to the development roller 51. In the present embodiment, a thin stainless-steel plate having spring elasticity and a thickness of 0.1 mm is used for the development blade 54, and the blade bias is applied such that the potential of the development blade 54 is −200 V relative to the potential of the development roller 51. In another example of the development blade 54, it may also be possible to use a configuration in which a polyamide elastomer, which is as an elastic member, is bonded to or formed by injection molding on a tip of a thin metal plate having spring elasticity, and the elastic member is brought into contact with the surface of the development roller 51 under a predetermined line pressure. In this case, when a pressing force applied by the development blade 54 to the development roller 51 is maintained by using the thin metal plate and the toner is, for example, a negatively charged toner, a charging property is imparted to the toner by the polyamide elastomer. The thin metal plate is not particularly limited as long as the thin metal plate can maintain the pressure contact force of the development blade 54. The elastic member can also be selected in consideration of the charging property of the toner. To impart additional charging performance, it is also possible to provide the elastic member with conductivity and use the elastic member in combination with the blade bias.

The backflow preventing member 55 is formed in the vicinity of the receiving opening 53b of the development unit 50. The backflow preventing member 55 includes an elongated sheet portion 55a extending in an X-axis direction of the receiving opening 53b, and a weight portion 55b that is formed in a part of the sheet portion 55a. A part of the sheet portion 55a is fixed to a development container of the development unit 50. The sheet portion 55a is a film-like sheet formed of resin such as polyethylene terephthalate (PET), Mylar®, or Kapton®, or rubber such as urethane rubber. The weight portion 55b has the effect of stabilizing the movement of the sheet portion 55a and directing the tip end of the backflow preventing member 55 toward a region T in the development position. One end of the sheet portions 55a is fixed to the development frame 53 with a double-sided adhesive tape, welding, or the like. A sheet made of Mylar® resin with a thickness of 100 μm is used as a sheet member for the backflow preventing member 55 according to the present embodiment. In a state where the development unit 50 is in the development position, an end of the sheet member is fixed to the development frame 53 on the +Z-direction side of the receiving opening 53b with a double-sided adhesive tape.

In the present embodiment, toner having a particle size of 6 μm and a normal negative charging polarity is used. For example, polymerized toner produced by a polymerization method is used as the toner according to the present embodiment. The toner according to the present embodiment is a so-called non-magnetic one-component developer that contains no magnetic components and is carried on the development roller 51 mainly by intermolecular forces or an electrostatic force (image-charge force). Alternatively, a one-component developer containing magnetic components may be used. The one-component developer may contain additives (e.g., wax or silica microparticles) for adjusting the fluidity and charging performance of toner, in addition to toner particles. As the developer, a two-component developer composed of non-magnetic toner and carrier having a magnetic property may be used. In the case of using a magnetic developer, for example, a cylindrical development sleeve in which a magnet is disposed is used as the developer carrying member.

The thickness of toner carried on the development roller 51 is regulated to a desired toner thickness by a contact pressure from the development blade 54. When a toner image is developed onto the surface of the photosensitive drum 2 in the development portion a, the circumferential velocity of the development roller 51 can be set to a velocity different from the circumferential velocity of the photosensitive drum 2 so as to obtain an appropriate image density. As a circumferential velocity ratio, it is suitable that the circumferential velocity of the development roller 51 be 0.5 to 3.0 times the circumferential velocity of the photosensitive drum 2. In the present embodiment, the circumferential velocity of the development roller 51 is 1.5 times the circumferential velocity of the photosensitive drum 2.

The supply roller 52 contacts the development roller 51 in a supply portion c to supply toner to the development roller 51 and peel off and collect, from the surface of the development roller 51, the toner (development residual toner) remaining on the development roller 51 not being used for development. From the viewpoint of supplying toner to the development roller 51 and peeling off development residual toner, the supply roller 52 may have, for example, a sponge structure using a foamed elastic member or a fur brush structure formed by planting fibers, such as rayon or nylon, on a core metal. As the sponge structure using the foamed elastic member, either a closed-cell structure in which the internal cells are independent of one another or an open-cell structure in which the internal cells are interconnected can be used. However, the open-cell structure may be more suitable because the amount of toner stored in the cells is large and thus the toner can be stably supplied. In the present embodiment, a foam roller is used in which a conductive elastic member, to which conductivity is imparted by dispersing carbon or the like, is provided on an open-cell polyurethane foam serving as a foamed elastic member, the open-cell polyurethane foam having interconnected cells with diameters of 10 to 800 μm, around a 5-mm-diameter metal core so that the foam roller has an outer diameter of 11 mm. The supply roller 52 formed of the foam roller is brought into contact with the development roller 51 and is rotated in a counter direction relative to the development roller 51, i.e., in a direction indicated by an arrow R4. In the present embodiment, the supply roller 52 is rotated such that a surface velocity of the supply roller 52 is 75% of a surface velocity of the development roller 51. From the viewpoint of supplying toner to the development roller 51 and removing development residual toner, the supply roller 52 may contact the development roller 51 with an interference amount in a range from 0.1 to 1.5 mm. In the present embodiment, the interference amount of the supply roller 52 with respect to the development roller 51 is 1.0 mm. A supply roller bias is applied to the metal core of the supply roller 52 by a voltage applying unit (not illustrated) so as to provide a predetermined potential difference between the supply roller 52 and the development roller 51. In the present embodiment, a supply roller bias of-200 V is applied relative to the potential of the development roller 51 so as to supply negatively chargeable toner.

### <Toner Supply Operation>

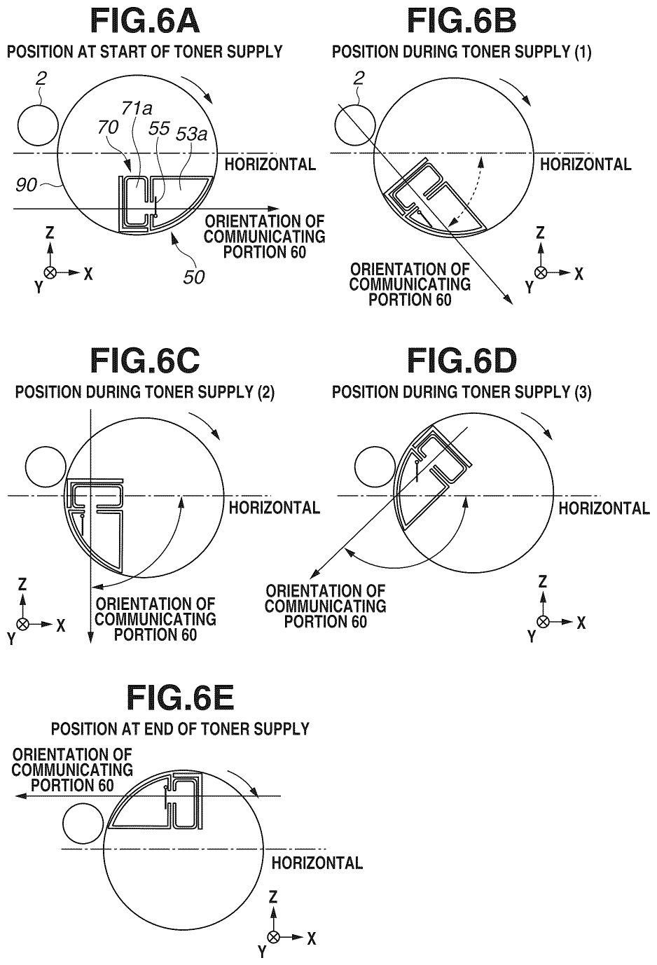

An operation for supplying toner from the toner cartridge 70 to the development unit 50 will be described with reference to FIGS. 6A to 6E. FIGS. 6A to 6E each illustrate a position (orientation) in which toner is supplied from the toner cartridge 70 to the development unit 50. A position (orientation) of the rotary main body 90 in which toner is supplied from the toner cartridge 70 to the development unit 50 during one revolution of the rotary main body 90 is referred to as a supply position.

The toner stored in the toner accommodating portion 71a is discharged through the discharge opening 71b and is received in the developing-side accommodating portion 53a through the receiving opening 53b. Since toner replenishment is performed by gravity-driven movement of toner, the supply position is a position in which an orientation of the communicating portion 60 defined by the discharge opening 71b of the toner cartridge 70 to be replenished and the receiving opening 53b of the development unit 50 is directed downward in the vertical direction relative to horizontal direction. In the present embodiment, the supply position for yellow starts when the communicating portion 60 is rotated even slightly clockwise from the position in which the communicating portion 60 is oriented horizontally, as illustrated in FIG. 6A. The rotary main body 90 then passes through positions in which the communicating portion 60 is directed downward relative to horizontal, as illustrated in FIGS. 6B, 6C, and 6D, and reaches a position in which the communicating portion 60 becomes horizontal again, as illustrated in FIG. 6E. When the communicating portion 60 defined by the discharge opening 71b of the toner cartridge 70 and the receiving opening 53b of the development unit 50 is horizontal or directed upward relative to horizontal, the communicating portion 60 is blocked by the backflow preventing member 55. Accordingly, toner does not flow back from the development unit 50 into the toner cartridge 70.

In this supply attitude, the toner accommodated in the toner accommodating portion 71a is discharged from the discharge opening 71b, and the toner discharged from the discharge opening 71b is accommodated in the developing-side accommodating portion 53a through the receiving opening 53b. The toner accommodated in the developing-side accommodating portion 53a is supplied to the development roller 51. The toner accommodated in the toner accommodating portion 71a through such a path is supplied to the development roller 51.

This toner supply operation may be performed during the image forming operation, or may be performed when an attachment of the toner cartridge 70 is detected. As a result, when the toner cartridge 70 accommodating new toner is attached, the supply of toner to the development unit 50 is started.

### <Toner Supply Path>

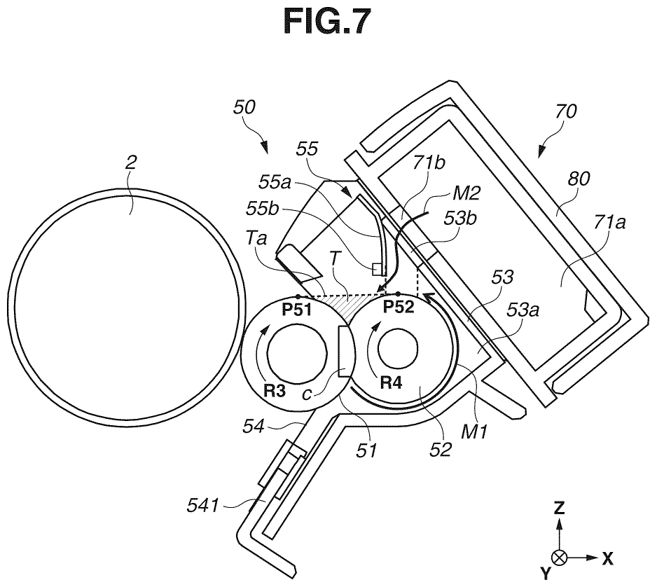

Next, a toner supply path to the development roller 51 will be described with reference to FIG. 7. FIG. 7 is a schematic sectional view illustrating a portion in the vicinity of the receiving opening 53b in a state where the development unit 50 is in the development position. An arrow M2 indicates a movement of toner from the toner cartridge 70. In FIG. 7, a common tangential line between the development roller 51 and the supply roller 52 on the receiving opening 53b side is represented by Ta, and a contact point between the common tangential line Ta and the development roller 51 and a contact point between the common tangential line Ta and the supply roller 52 are represented by P51 and P52, respectively. The region T that is surrounded by the contact points P51 and P52 and the supply portion c is indicated by a shaded area.

As described above, the discharge opening 71b faces the receiving opening 53b in a state where the toner cartridge 70 is in the attachment position with respect to the development frame 53. In other words, the toner accommodating portion 71a of the toner cartridge 70 and the developing-side accommodating portion 53a of the development unit 50 communicate with each other through the discharge opening 71b and the receiving opening 53b. The toner accommodated in the toner accommodating portion 71a is discharged from the discharge opening 71b, and the toner discharged from the discharge opening 71b is accommodated in the developing-side accommodating portion 53a through the receiving opening 53b. In this case, the receiving opening 53b is arranged only in a part of the development frame 53 in the longitudinal direction. In the present embodiment, the receiving opening 53b is arranged at a single location in a central portion in the longitudinal direction of the development frame 53.

The toner accommodated in the developing-side accommodating portion 53a is supplied to the development roller 51 by the supply roller 52. The supply roller 52 according to the present embodiment is in contact with the development roller 51 with a predetermined interference amount in the supply portion c, so that the cells of the supply roller 52 are in contact in a compressed state in the supply portion c. When the supply roller 52 rotates in the direction indicated by the arrow R4, the compressed cells are released downstream of the supply portion c in the direction indicated by the arrow R4, so that toner in the region T is taken into the cells, and toner remaining on the development roller 51 is scraped off and collected by walls. When the cells are compressed on an upstream side of the supply portion c in the direction indicated by the arrow R4, toner in the cells is discharged and supplied to the development roller 51. In this case, the toner in the vicinity of the upstream side of the supply portion c in the direction indicated by the arrow R4 is pushed out by the toner discharged from the supply roller 52 and moves in a direction indicated by an arrow M1 in a gap between the supply roller 52 and the development container.

The toner that has moved in the direction indicated by the arrow M1 is mixed with other toner in the region T in the developing-side accommodating portion 53a, and is taken into the cells of the supply roller 52 again in the supply portion c.

Thus, the toner accommodated in the developing-side accommodating portion 53a is supplied to the development roller 51 by the supply roller 52 while being circulated in the direction indicated by the arrow M1.

Along with the rotation of the development roller 51 and the supply roller 52, the toner accommodated in the developing-side accommodating portion 53a also moves in the longitudinal direction together with the circulation of toner in the direction indicated by the arrow M1, so that the supplied new toner is mixed with degraded toner.

### <Exposure Control Configuration>

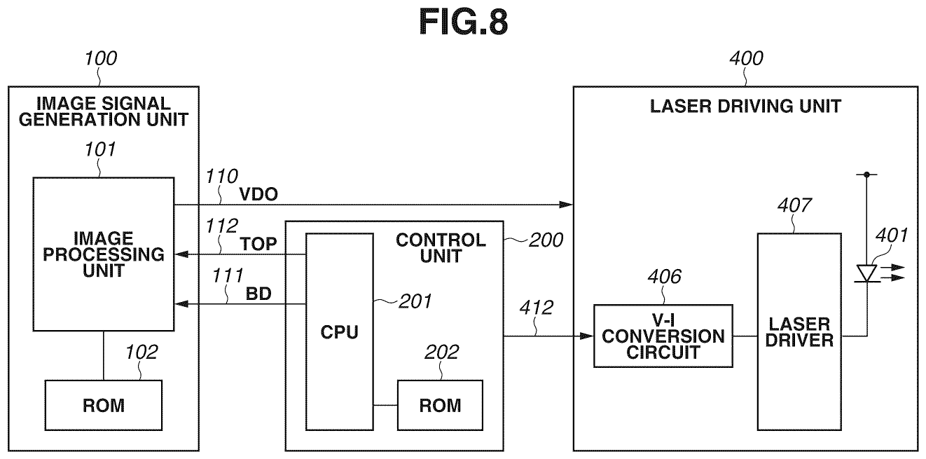

FIG. 8 illustrates a schematic configuration of each portion used for exposure control. FIG. 8 illustrates a control unit 200, an image signal generation unit 100, and a laser driving unit 400 that drives the scanner to emit laser light.

The image signal generation unit 100 receives image data from a host computer (not illustrated) and generates video data (VDO) signals 110 as image signals. The image signal generation unit 100 includes a function for correcting image density. The control unit 200 controls an overall operation of the image forming apparatus 1. The laser driving unit 400 includes a laser driver integrated circuit (IC) 407. The laser driver IC 407 controls ON/OFF of light emission of a light-emitting unit 401 based on the VDO signals 110. The image signal generation unit 100 transmits a print start instruction to the control unit 200 when the output of image signals for image formation is ready. The control unit 200 includes a central processing unit (CPU) 201. When the control unit 200 is ready for printing, a TOP signal 112 that is a sub-scanning synchronization signal and a BD signal 111 that is a main scanning synchronization signal are transmitted to the image signal generation unit 100. In response to receiving these synchronization signals, the image signal generation unit 100 outputs VDO signals 110 as image signals to the laser driving unit 400 at a predetermined timing.

The control unit 200 includes the CPU 201, a read-only memory (ROM) 202, a digital-to-analog (D/A) converter (not illustrated), and a regulator (not illustrated). The control unit 200 and the laser driving unit 400 constitute a luminance correction unit. The laser driving unit 400 includes a V-I conversion circuit 406 for converting a voltage into a current, and the laser driver IC 407. The laser driving unit 400 supplies a drive current to the light-emitting unit 401 that is a laser diode serving as a light source for the scanner 4. The ROM 202 stores information about a correction current to be supplied to the light-emitting unit 401.

Next, an operation of the laser driving unit 400 will be described. Based on the information indicating the correction current for the light-emitting unit 401 and is stored in the ROM 202, the control unit 200 outputs a luminance correction analog voltage 412 that increases or decreases in the main scanning direction (Y-direction) with respect to the photosensitive drum 2 in synchronization with the BD signal 111. The luminance correction analog voltage 412 is converted into a current value by the subsequent-stage V-I conversion circuit 406, and is output to the laser driver IC 407.

The laser driver IC 407 automatically adjusts the luminance through feedback control using a circuit within the laser driver IC 407 so that the light amount detected by a photodetector (not illustrated) provided in the scanner 4 serving as a light amount monitor for the light-emitting unit 401 becomes a desired luminance. A so-called auto power control (APC) is performed. The luminance of the light-emitting unit 401 is automatically adjusted while the light-emitting unit 401 is caused to emit light to detect the BD signal 111 outside of the print region for each main scanning line.

As a luminance correction method for the light-emitting unit 401, a current required to obtain a predetermined luminance is automatically adjusted by APC, and the luminance correction analog voltage 412 is controlled based on the information that indicates the correction current to be supplied to the light-emitting unit 401 and is stored in the ROM 202. For example, a correction operation for increasing the luminance is performed by subtracting, from the drive current for the light-emitting unit 401, the current amount indicated in the correction current information. The correction current information to be stored in the ROM 202 can be adjusted at 256 levels of 00 h to FFh, and the amount of laser light can be changed by +0.1 [μJ/cm²] at a maximum. In the present embodiment, the amount of exposure can be adjusted for each of 17 laser irradiation sections “0” to “16” that are divided in the longitudinal direction.

### <Image Processing>

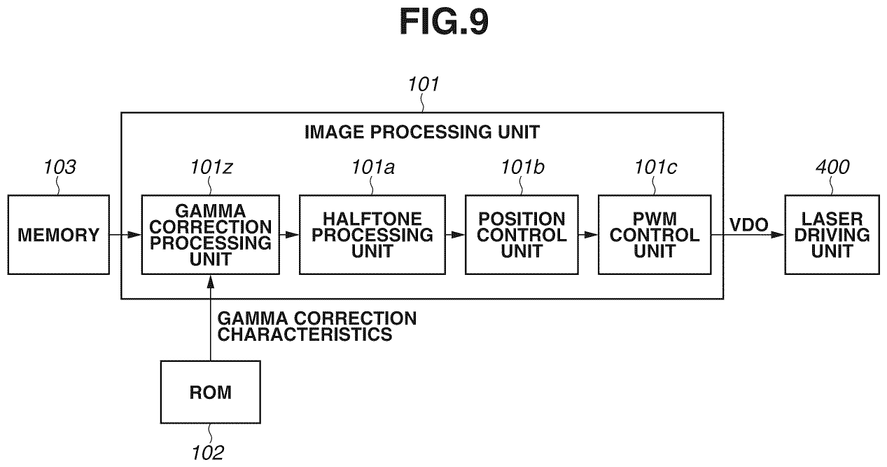

An image processing of the image forming apparatus 1 will be described with reference to FIG. 9. FIG. 9 is a functional block diagram illustrating image processing during printing. An image processing unit 101 includes a gamma correction processing unit 101z, a halftone processing unit 101a, a position control unit 101b, and a pulse width modulation (PWM) control unit 101c as illustrated in FIG. 9, and executes image processing as described below.

The image forming apparatus 1 according to the present embodiment performs image processing to obtain continuous halftone images by gradation conversion based on a dither method. Print data input from the host computer (not illustrated) is temporarily stored in a memory 103. The print data includes input image data, recording position information indicating a recording position of each pixel of the image data on the photosensitive drum 2, and information indicating the number of printed sheets since toner supply is started. The print data is read out from the memory 103, and the gamma correction processing unit 101z performs gamma correction processing on the image data included in the print data.

The gamma correction processing unit 101z refers to gamma correction characteristics stored in a ROM 102 based on the input print information. Gamma correction processing (density correction processing) is performed on the input image data to generate data subjected to gamma correction. The gamma correction processing is processing for correcting an input gradation value for each pixel of input image data to a corrected gradation value based on the gamma correction characteristics so that the output density of each pixel of the input image data becomes an output density according to the desired gamma characteristics. Image data after gamma correction is hereinafter referred to as gamma correction data.

The ROM 102 stores the gamma correction characteristics for each position (recording position L) in the main scanning direction.

For example, a predetermined number of pixels that are consecutive in the main scanning direction are treated as one region, and gamma correction characteristics are stored for each region. The gamma correction processing unit 101z selectively refers to the gamma correction characteristics, stored in the ROM 102, that correspond to recording position information included in the print data.

The gamma correction processing unit 101z outputs gamma correction data to the halftone processing unit 101a. The halftone processing unit 101a performs multi-value dithering processing on the print data with a bit depth of 8 bits (256 gradations) to convert the print data into image data with a bit depth of 5 bits (32 gradations). The position control unit 101b adds 2-bit position control data representing a dot growth direction to the image data to be output from the halftone processing unit 101a using a position control matrix corresponding to a dithering matrix used for multi-value dithering processing by the halftone processing unit 101a. The PWM control unit 101c performs PWM control to convert 7-bit image data to which position control data is added into the VDO signal 110 as a pulse signal, and outputs the pulse signal to the laser driving unit 400.

Through the image processing using the dither method as described above, print data is converted into the VDO signal 110 for exposure subjected to halftone processing for appropriate gradation representation in the image forming apparatus 1.

### <Gamma Correction Processing>

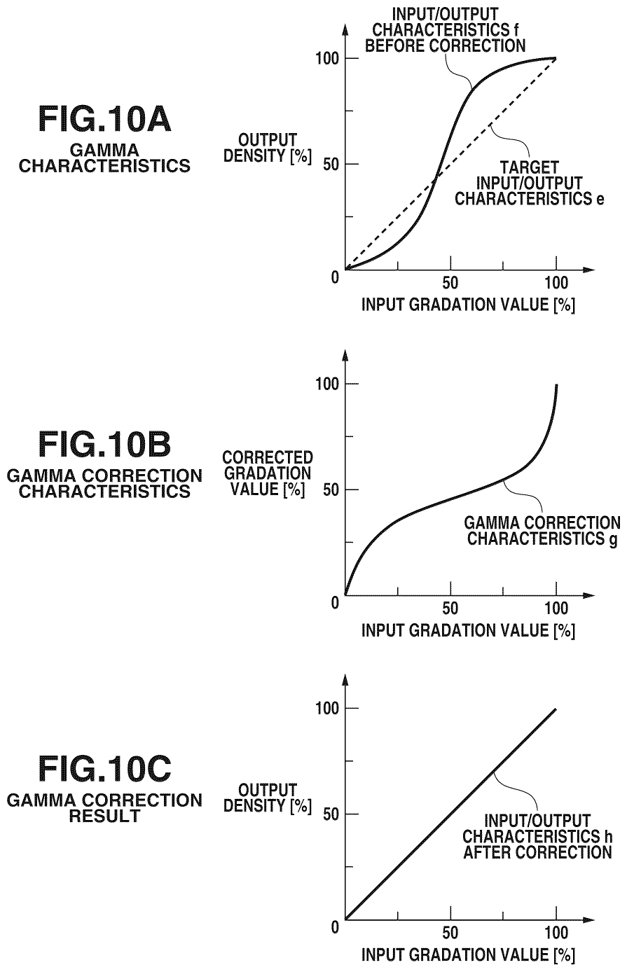

Gamma correction processing to be performed by the gamma correction processing unit 101z will be described. FIG. 10A is a graph illustrating gamma characteristics in which the horizontal axis represents a gradation value (input gradation value) for image data input to the image processing unit 101, and the vertical axis represents an output density of an image to be output from the image forming apparatus 1. Target input/output characteristics are referred to as input/output characteristics e. In the present embodiment, input/output characteristics in which the input gradation value corresponds to the output density are used as the input/output characteristics e. However, the input/output characteristics e are not limited to such characteristics. On the other hand, input/output characteristics having non-linear characteristics with respect to an input gradation value due to process characteristics (development efficiency, etc.) of the image forming apparatus 1 are referred to as input/output characteristics f.

Gamma correction characteristics g are gamma correction characteristics for making the input/output characteristics f at the recording position L approach the target input/output characteristics e. FIG. 10B is a graph illustrating the gamma correction characteristics g in which the horizontal axis represents a gradation value (input gradation value) for image data input to the image processing unit 101, and the vertical axis represents a corrected gradation value to be output. The gamma correction characteristics g can be obtained by calculating an offset in input gradation value direction from the input/output characteristics e to the input/output characteristics f at the same output density. Conversion of image data using the gamma correction characteristics g enables the input/output characteristics f having non-linear characteristics as illustrated in FIG. 10A to substantially match the target input/output characteristics e. Specifically, when image formation is performed using corrected gradation values as input, an image having an output density according to the resulting input/output characteristics h is formed, where the resulting input/output characteristics h are substantially the same as the target input/output characteristics e, as illustrated in FIG. 10C.

When the state of the image forming apparatus 1 changes from a state A to a state B, the larger a change in output density for a given input gradation value according to the input/output characteristics f (gamma characteristics) before correction is, the larger a change in input gradation value direction at a given output density becomes. Accordingly, to make the input/output characteristics f approach the target input/output characteristics e, a change amount of a gradation correction amount in the gamma correction characteristics is also increased.

The use of gamma correction characteristics as described above enables the input/output characteristics at the recording position L to substantially coincide with the target input/output characteristics.

### <Density Unevenness>

Next, density unevenness that is an issue to be solved will be described. Density unevenness occurs in the rotational axis direction of the development roller 51. In the present embodiment, the rotational axis direction of the development roller 51 is substantially parallel to the main scanning direction of the scanner 4 and corresponds to the Y-direction. Accordingly, latent image forming conditions in the main scanning direction of the scanner 4 are controlled to reduce density unevenness in the rotational axis direction of the development roller 51. The rotational axis direction of the development roller 51 is hereinafter referred to as the longitudinal direction, and a position in the longitudinal direction is referred to as a longitudinal position.

The toner accommodated in the developing-side accommodating portion 53a is carried on the development roller 51 and is subjected to mechanical stress through frictional contact with the development blade 54, the photosensitive drum 2, the supply roller 52, and the like, so that the toner gradually degrades. As toner degradation progresses, frictional charging performance decreases for toner deformed from an original particle shape and for toner from which external additives have been peeled off from the particle surface. The charge amount during development of degraded toner damaged within the developing-side accommodating portion 53a differs from that of new toner.

When new toner is supplied from the toner cartridge 70 to the development unit 50, new toner is gradually mixed with the deteriorated toner in the developing-side accommodating portion 53a. When the new toner is supplied onto the development roller 51 and the charge amount of the toner on the development roller 51 increases as compared with the charge amount before toner supply, the image density changes before and after toner supply. As the ratio of new toner to be supplied onto the development roller 51 increases, the charge amount greatly changes and the image density also greatly changes.

Immediately after toner supply, new toner is supplied from the receiving opening 53b to the development chamber. Accordingly, a larger amount of new toner is present at longitudinal positions closer to the receiving opening 53b. In other words, the ratio of new toner at a longitudinal position (opening longitudinal position) P2 on the opening region Q2 including the receiving opening 53b is higher than that at a longitudinal position (non-opening longitudinal position) P1 on the non-opening region Q1 in which the receiving opening 53b is not disposed. For this reason, the charge amount of toner at the opening longitudinal position P2 changes more than that at the non-opening longitudinal position P1 before and after toner replenishment, and the image density also changes more greatly. In particular, in a halftone density region on the low-gradation side, toner is more likely to be developed onto an electrostatic latent image on the surface of the photosensitive drum 2 as the charge amount of toner increases, so that the density at the opening longitudinal position P2 tends to increase. As a result, density unevenness occurs due to the difference in the charge amount of toner in the longitudinal direction. In particular, in a configuration in which toner is supplied from the receiving opening 53b to the region T, new toner is more likely to be supplied to the supply roller 52 and the development roller 51 before new toner supplied to the opening longitudinal position P2 moves in the longitudinal direction. For this reason, density unevenness is likely to occur.

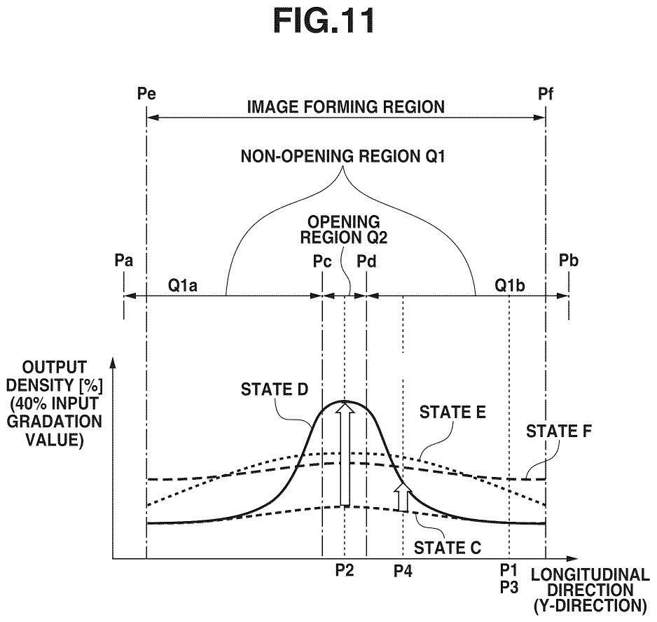

An example of such density unevenness will be described with reference to FIG. 11. FIG. 11 is a graph illustrating an output density at each longitudinal position in 40% gradation level as a representative value of gamma characteristics. FIG. 11 illustrates an output density based on gamma characteristics in an image forming state C before toner supply, in an image forming state D immediately after toner supply, in an image forming state E after 10 sheets are printed since the toner supply, and in an image forming state F after 100 sheets are printed since the toner supply. In the state C before toner supply, the developing-side accommodating portion 53a is in a state where deteriorated toner is present on the entire region in the longitudinal direction. Since the charge amount of degraded toner is low, the gamma characteristics in the longitudinal direction exhibit low output density over the entire region. The gamma characteristics in the longitudinal direction vary due to unevenness in the amount of light of the scanner 4 in the longitudinal direction, or the like. In the state D immediately after toner supply, the closer to the opening longitudinal position P2 where the receiving opening 53b is disposed, the higher the ratio of new toner becomes. Accordingly, the density at the opening longitudinal position P2 fluctuates to a higher-density side than the non-opening longitudinal position P1. The density at a non-opening longitudinal position P4 from which a shortest distance to the receiving opening 53b is shorter than the shortest distance from the non-opening longitudinal position P3 fluctuates to a higher-density side than the non-opening longitudinal position P3. Thus, when the state transitions to the state D immediately after toner supply from the state C before toner supply, the gamma characteristics at each longitudinal position change, so that density unevenness occurs.

Such density unevenness is gradually reduced as new toner is gradually mixed with degraded toner in the longitudinal direction along with the rotation of the development roller 51 and the supply roller 52 (development rotation) during image formation or the like after toner supply, so that the ratio of new toner becomes uniform. As the number of printed sheets increases as the state transitions to the state E and the state F from the state D immediately after toner supply, the ratio of new toner at the opening longitudinal position P2 decreases, so that the image density decreases. The amount of change in gamma characteristics at each longitudinal position from the state D immediately after toner supply decreases as the number of printed sheets increases as the state transitions to the state E and the state F.

However, shortening the duration of development rotation during toner supply leads to an increase in density unevenness. On the other hand, in order to prevent occurrence of density unevenness, it is conceivable to perform the rotation operation of the development roller 51 or the rotation operation of the rotary main body 90 before image formation for a long period of time, or a plurality of times. However, this increases a user wait time (downtime), thereby reducing user convenience. In addition, degradation of the developer progresses, making it difficult to achieve a long service life.

Density unevenness particularly tends to be pronounced in a configuration without a screw member for conveying toner in the longitudinal direction. On the other hand, a configuration in which a toner conveyance member for conveying supplied new toner in the longitudinal direction is added to the development chamber so as to prevent occurrence of density unevenness leads to an increase in cost and an increase in the size of the image forming apparatus 1.

If toner patches are formed at a plurality of positions in the longitudinal direction after toner supply and density detection results are used to reduce density unevenness, density detection sensors need to be provided at the plurality of positions in the longitudinal direction, which leads to an increase in cost and an increase in the size of image forming apparatus 1. It is necessary to form toner patches at the plurality of positions in the longitudinal direction so as to reduce density unevenness, so that the amount of toner corresponding to the number of toner patches is consumed. Further, to reduce density unevenness, toner patches need to be formed at an appropriate toner supply timing and at an appropriate timing for subsequent image formation; however, the frequency of forming toner patches increases, which may increase toner consumption and a user's wait time.

As described above, it is difficult to reduce density unevenness caused by toner supply in a typical image forming apparatus.

### <Outline of Control of Latent Image Forming Conditions>

Control of latent image forming conditions to reduce density unevenness according to the present embodiment will be described below. To reduce density unevenness in accordance with the toner supply timing and the longitudinal position of the receiving opening 53b, conditions for forming an electrostatic latent image in the longitudinal direction are controlled. This makes it possible to reduce density unevenness due to toner supply.

In the present embodiment, latent image forming conditions to be controlled include luminance correction of laser light and image processing such as gamma correction processing. Density unevenness can also be reduced using a combination of these processes.

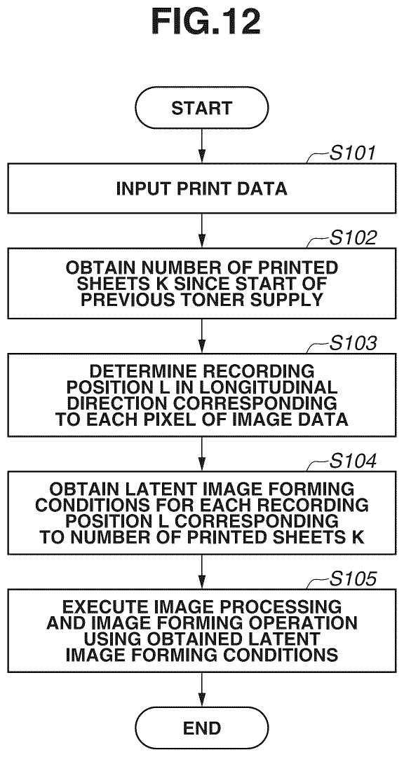

FIG. 12 is a flowchart illustrating processing to be executed in the control unit 200. First, in step S101, print data is input to the image forming apparatus 1. In step S102, the number of printed sheets K since the start of the previous toner supply is obtained. To control latent image forming conditions for each longitudinal position, in step S103, the recording position L in the longitudinal direction corresponding to each pixel of the image data is determined. In step S104, the latent image forming conditions for each recording position L corresponding to the number of printed sheets K are obtained. In step S105, image processing and image forming operation are executed using the obtained latent image forming conditions.

In this case, the latent image forming conditions are controlled so as to reduce a density change amount at each longitudinal position, depending on the number of printed sheets K since the start of the previous toner supply. Before and after toner supply, a change amount of the latent image forming conditions from before toner supply to immediately after toner supply is set to be larger at longitudinal positions closer to the receiving opening 53b. Thereafter, as the number of printed sheets K increases, the change amount of the latent image forming conditions from the pre-supply condition is reduced at the opening longitudinal position P2 where the receiving opening 53b is disposed. In the present embodiment, latent image forming conditions for each longitudinal position that can reduce density change amounts for different values of the number of printed sheets K are stored in advance, and latent image forming conditions corresponding to the number of printed sheets K during printing are obtained by interpolation calculation to control the latent image forming conditions for each longitudinal position. Accordingly, density unevenness due to toner supply can be reduced.

In the present embodiment, the latent image forming conditions are controlled based on the number of printed sheets K. Alternatively, a rotational distance of the development roller 51 accumulated during the image forming operation or the like, a residual toner amount in the development unit 50, and the like that are correlated with the number of printed sheets K can also be used.

Another method may be used as the method for obtaining latent image forming conditions in step S104. It is also possible to use a method in which, for example, toner patches are formed at one or more positions in the longitudinal direction and latent image forming conditions for each recording position L are corrected based on correction information for each recording position L corresponding to the preliminarily stored number of printed sheets K using the latent image forming conditions obtained as a result of density detection as a reference. Also, in such a configuration, it is possible to suppress an increase in cost and an increase in the size of the image forming apparatus 1 and to reduce the amount of toner to be consumed as compared with the case of forming a plurality of toner patches in the longitudinal direction, and it is also possible to reduce density unevenness due to toner supply.

### <Details of Control of Latent Image Forming Conditions>

An example of control of latent image forming conditions in the image forming state C before toner supply, in the image forming state D immediately after toner supply, in the image forming state E after 10 sheets have been printed since the toner supply, and in the image forming state F after 100 sheets have been printed since the toner supply will be described below. A case where latent image forming conditions for single-color image data are controlled is described below as an example. However, in the case of color printing, similar processing can be applied to each of the yellow image data, the magenta image data, the cyan image data, and the black image data.

### Example 1

In Example 1, gamma correction processing is controlled as latent image forming conditions to be controlled as described above so as to reduce density unevenness. In Example 1, even at the same halftone level, a light emission period for each pixel is changed by controlling gamma correction characteristics, thereby reducing density unevenness.

The ROM 102 of the image signal generation unit 100 stores a plurality of gamma correction characteristics for each longitudinal position (recording position L) for different values of the number of printed sheets K since start of toner supply. The gamma correction characteristics corresponding to the recording position information are obtained depending on the number of printed sheets K since toner supply is started, and gamma correction processing is executed by the gamma correction processing unit 101z. In a case where density unevenness occurs depending on a pixel position in the longitudinal direction, gamma correction processing is performed for each pixel of the image data based on gamma correction characteristics corresponding to the pixel position in the longitudinal direction.

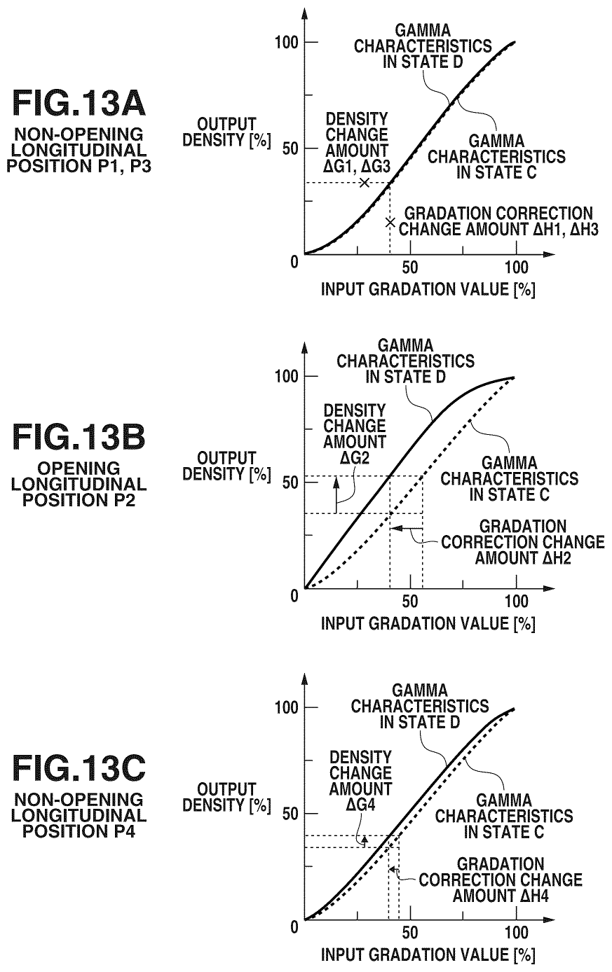

FIGS. 13A, 13B, and 13C are graphs each illustrating a fluctuation in gamma characteristics before and after toner supply at the non-opening longitudinal positions P1 and P3, the opening longitudinal position P2, and the non-opening longitudinal position P4 illustrated in FIG. 11. A dotted curve represents gamma characteristics in the state C before toner supply. A solid curve represents gamma characteristics in the state D immediately after toner supply. The amounts of change in the direction in which the output density of gamma characteristics during a state change is increased at the longitudinal positions P1 to P4 are defined as density change amounts ΔG1 to ΔG4, respectively. The amounts of change in the direction in which the input gradation value of gamma correction characteristics required to make the density to approach a target density with the same gradation during a state change is decreased at the longitudinal positions P1 to P4 are defined as gradation correction change amounts ΔH1 to ΔH4, respectively. The density change amounts and the gradation correction change amounts may have negative values particularly for halftones on a high gradation side. In the following description, the absolute values of the change amounts in the same direction (i.e., the same sign) are compared.

During the change from the state C before toner supply to the state D immediately after toner supply, new toner is more likely to enter the opening region Q2 where the receiving opening 53b is present, so that the ratio of new toner increases and the amount of change in gamma characteristics before and after toner supply increases. On the other hand, at the non-opening longitudinal positions P1 and P3 within the non-opening region Q1, the ratio of new toner in the state C does not change between the state C and the state

D, so that gamma characteristics remain substantially unchanged. In other words, the amount of change in gamma characteristics before and after toner supply at the opening longitudinal position P2 is larger than that at the non-opening longitudinal position P1 (ΔG2>ΔG1). New toner is also moved in the longitudinal direction into the non-opening region Q1 from the opening region Q2 when toner is supplied, so that the ratio of new toner increases at positions closer to the receiving opening 53b and the amount of change in gamma characteristics before and after toner supply increases. In other words, the amount of change in gamma characteristics before and after toner supply at the non-opening longitudinal position P4 from which the shortest distance to the receiving opening 53b is shorter than the shortest distance from the non-opening longitudinal position P3 is larger than that at the non-opening longitudinal position P3 (ΔG4>ΔG3).

In contrast, such gamma characteristics are obtained in advance by experiments, for example, and gamma correction characteristics calculated from the gamma characteristics for each longitudinal position (recording position L) before and after toner supply are stored in the ROM 102 and are used for gamma correction processing. Specifically, in gamma correction processing before and after toner supply, the amount of change in gamma correction characteristics at the opening longitudinal position P2 has a greater absolute value than that at the non-opening longitudinal position P1 in the same direction (ΔH2>ΔH1). In gamma correction processing before and after toner supply, the amount of change in gamma correction characteristics at the non-opening longitudinal position P4 from which the shortest distance to the receiving opening 53b is shorter than the shortest distance from the non-opening longitudinal position P3 has a greater absolute value than that at the non-opening longitudinal position P3 in the same direction (ΔH4>ΔH3). The amount of change in the light emission period of the scanner 4 for pixels having the same halftone level after halftone processing also changes in a manner similar to the amount of change in the gamma correction characteristics. As a result of such gamma correction processing, the halftone density at both the non-opening longitudinal position P1 and the opening longitudinal position P2 approaches the target density, thereby reducing density unevenness in the longitudinal direction. The halftone density at both the non-opening longitudinal position P3 and the non-opening longitudinal position P4 approaches the target density, thereby reducing density unevenness in the longitudinal direction

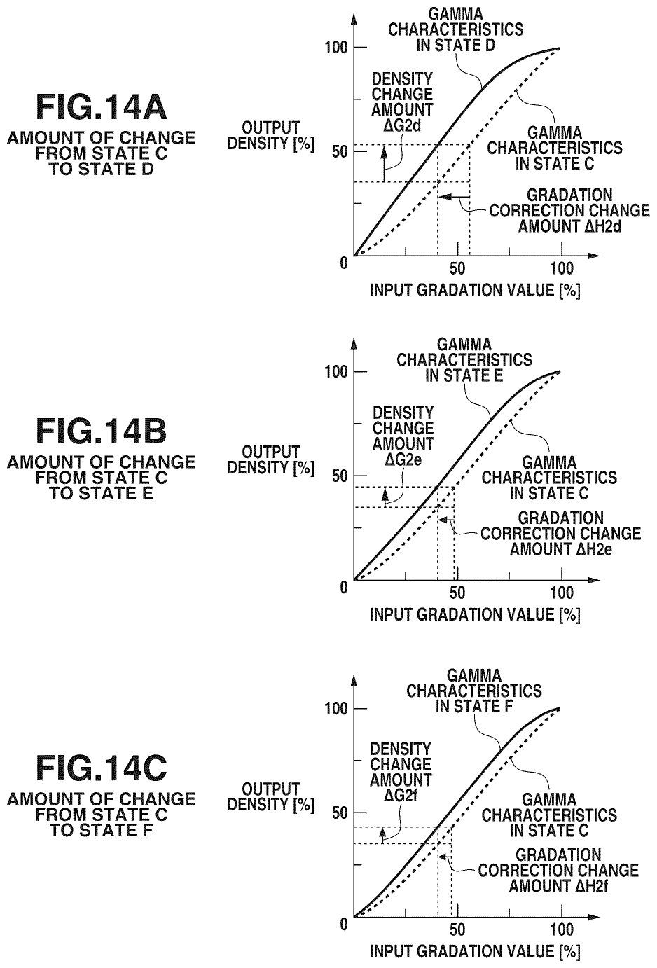

FIGS. 14A, 14B, and 14C are graphs each illustrating a fluctuation in gamma characteristics at the opening longitudinal position P2 illustrated in FIG. 11 for the state

D, the state E, and the state F, respectively, having different numbers of printed sheets since toner supply, with the state C before toner supply as a reference. The amounts of change in the direction in which the output density of gamma characteristics during a state change increases at the longitudinal position P2 in the state D, the state E, and the state F from the state C are defined as ΔG2d, ΔG2e, and ΔG2f, respectively. The amounts of change in the direction in which the input gradation value of gamma correction characteristics required to make the density approach a target density for the same gradation level decreases during the state change at the longitudinal position P2 in the state D, the state E, and the state F from the state C are defined as ΔH2d, ΔH2e, and ΔH2f, respectively.

During the transition from the state D immediately after toner supply to the state E and the state F as the number of printed sheets K increases, a larger amount of new toner on the opening region Q2 and degraded toner filled the entire longitudinal region before toner supply move in the longitudinal direction and are mixed together with the development rotation. As the amount of toner in the space of the developing-side accommodating portion 53a increases due to toner supply during the image forming operation or before and after the image forming operation, or as the amount of new toner remaining in the toner accommodating portion 71a decreases, the amount of new toner supplied from the receiving opening 53b decreases. Accordingly, the ratio of new toner at the opening longitudinal position P2 where the receiving opening 53b is disposed decreases, and the amount of change in gamma characteristics that are changed after toner supply from the state C before toner supply decreases. In other words, at the opening longitudinal position P2, the amount of change in gamma characteristics that are changed after toner supply from the state C before toner supply gradually decreases as the number of printed sheets K advances (ΔG2d>ΔG2e>ΔG2f). According to Example 1, in the state F in which the number of printed sheets K is 100, new toner and degraded toner are uniformly mixed in the longitudinal direction. Therefore, the gamma characteristics in the state F change from the state C on the entire region in the longitudinal direction. However, the longitudinal difference in the gamma characteristics is substantially the same as the longitudinal difference in the gamma characteristics in the state C before toner supply. In the state F and subsequent states, even when the number of printed sheets K has advanced, the amount of change in gamma characteristics is small until toner supply is started.

In contrast, such gamma characteristics are obtained in advance by experiments, for example, and gamma correction characteristics calculated from the gamma characteristics for each longitudinal position (recording position L) and for the number of printed sheets K are stored in the ROM 102 and are used for gamma correction processing. Specifically, at the opening longitudinal position P2, the amount of change in gamma correction characteristics to be changed after toner supply from the pre-supply state C is set to have a smaller absolute value in the same direction as the number of printed sheets K increases (ΔH2d>ΔH2e>ΔH2f). The amount of change in the light emission period of the scanner 4 for pixels having the same halftone level after halftone processing also has a relation similar to that of the amount of change in gamma correction characteristics. As a result of such gamma correction processing, the halftone density at both the non-opening longitudinal position P1 and the opening longitudinal position P2 approaches the target density regardless of the number of printed sheets K after toner supply, so that density unevenness in the longitudinal direction can be reduced.

Thus, the correction amount for the gamma correction processing can be appropriately determined depending on the toner supply timing and the longitudinal position of the receiving opening 53b. Thus, density unevenness due to toner supply can be reduced.

### Comparative Examples 1 to 4

Comparative Example 1 is an example where the amount of change in gamma correction characteristics is not varied in accordance with toner supply timing, unlike in Example 1. Comparative Example 2 and Comparative Example 3 are examples where the amount of change in gamma correction characteristics is not varied in accordance with the longitudinal position of the receiving opening 53b, unlike in Example 1. Comparative Example 4 is an example where the amount of change in gamma correction characteristics is varied in accordance with the longitudinal position of the receiving opening 53b in a direction opposite to that in Example 1, unlike in Example 1.

In Comparative Example 1, the gamma correction characteristics that are matched with the gamma characteristics for each longitudinal position in the state C before toner supply are used for all the states C to F.

In Comparative Example 2, the gamma correction characteristics that are matched with the gamma characteristics for each longitudinal position in the state C before toner supply are used in the state C. In the state D, the state E, and the state F, the change amount ΔH2 of gamma correction characteristics from the state C to the state D obtained by matching the gamma correction characteristics with the gamma characteristics at the opening longitudinal position P2 in the state D immediately after toner supply is used as the change amount ΔH of gamma correction characteristics for all longitudinal positions.

In Comparative Example 3, the gamma correction characteristics that are matched with the gamma characteristics for each longitudinal position in the state C before toner supply are used in the state C. In the state D, the state E, and the state F, the gamma correction characteristics that are matched with the gamma characteristics for each longitudinal position in the state F after 100 sheets have been printed since the toner supply are used.

In Comparative Example 4, the gamma correction characteristics that are matched with the gamma characteristics for each longitudinal position in the state C before toner supply are used in the state C. In the state D, the state E, and the state F, the gamma correction characteristics that are matched with the gamma characteristics at the opening longitudinal position P2 in the state C before toner supply are used for all longitudinal positions.

Table 1 presents gradation correction change amounts ΔH (ΔH2 and ΔH1) of gamma correction characteristics at the opening longitudinal position P2 and the non-opening longitudinal position P1 during a change from the state C to the state D according to Example 1 and Comparative Examples 1 to 4. Table 2 presents gradation correction change amounts ΔH (ΔH4 and ΔH3) of gamma correction characteristics at the non-opening longitudinal position P4 and the non-opening longitudinal position P3 during a change from the state C to the state D according to Example 1 and Comparative Examples 1 to 4. The gradation correction change amounts ΔH in Table 1 and Table 2 are examples of values of correction amounts for input gradation values in the gamma correction characteristics for a target output density of 40% after correction.

Table 1 presents the comparative relation between the gradation correction change amount ΔH2 and the gradation correction change amount ΔH1 at each longitudinal position. In Example 1, ΔH2 is larger than ΔH1, while in Comparative Examples 1 to 4, ΔH2 and ΔH1 are equal, or ΔH2 is smaller than ΔH1. Table 2 presents the comparative relation between the gradation correction change amount ΔH3 and the gradation correction change amount ΔH4 at each longitudinal position. In Example 1, Δ4 is larger than ΔH3, while in Comparative Examples 1 to 4, ΔH4 and ΔH3 are equal, or ΔH4 is smaller than ΔH3.

Table 1 and Table 2 present evaluation results of density unevenness in the state D immediate after toner supply according to Example 1 and Comparative Examples 1 to 4.

TABLE 1

| | Gradation Correction Change Amount ΔH | | | |
|---|---|---|---|---|
| | Opening | Non-opening | | |
| | Longitudinal | Longitudinal | Comparative | Density |
| | Position P2 | Position P1 | Relation | Unevenness |
| Example 1 | 16.2% | 0% | ΔH2 > ΔH1 | Acceptable |
| Comparative | 0% | 0% | ΔH2 = ΔH1 | Not |
| Example 1 | | | | Acceptable |
| Comparative | 16.2% | 16.2% | ΔH2 = ΔH1 | Not |
| Example 2 | | | | Acceptable |
| Comparative | 7.0% | 7.0% | ΔH2 = ΔH1 | Not |
| Example 3 | | | | Acceptable |
| Comparative | 0% | 1.9% | ΔH2 < ΔH1 | Not |
| Example 4 | | | | Acceptable |

TABLE 2

| | Gradation Correction Change Amount ΔH | | | |
|---|---|---|---|---|
| | Non-opening | Non-opening | | |
| | Longitudinal | Longitudinal | Comparative | Density |
| | Position P4 | Position P3 | Relation | Unevenness |
| Example 1 | 4.5% | 0% | ΔH4 > ΔH3 | Acceptable |
| Comparative | 0% | 0% | ΔH4 = ΔH3 | Not |
| Example 1 | | | | Acceptable |
| Comparative | 16.2% | 16.2% | ΔH4 = ΔH3 | Not |
| Example 2 | | | | Acceptable |
| Comparative | 7.0% | 7.0% | ΔH4 = ΔH3 | Not |
| Example 3 | | | | Acceptable |
| Comparative | 0.4% | 1.9% | ΔH4 < ΔH3 | Not |
| Example 4 | | | | Acceptable |

### (Evaluation Method)

A halftone image with a density of 40% was formed as an evaluation image for density unevenness for each of the states C to F corresponding to the toner supply timing. Density unevenness was determined by visually comparing densities in the longitudinal direction based on the following criteria.
Acceptable: No density unevenness is observed.
Not Acceptable: Density unevenness is observed.

### Comparison Between Example 1 and Comparative Examples 1 to 4

In Comparative Example 1, as in Example 1, in the state C before toner supply, gamma correction processing is performed at each longitudinal position to thereby prevent density unevenness in the longitudinal direction from occurring due to the characteristics of the scanner 4.

Accordingly, in the state C before toner supply, the density at each longitudinal position matches the target density, so that density unevenness does not occur. However, in the state D immediately after toner supply, gamma characteristics change depending on the longitudinal position of the receiving opening 53b before and after toner supply, so that density unevenness occurs. Also, in the state E after 10 sheets have been printed since the toner supply, the change in gamma characteristics depending on the longitudinal position from the state before toner supply remains, so that density unevenness occurs.

In Comparative Example 2, as in Example 1, in the state C before toner supply, the density at each longitudinal position matches the target density, so that density unevenness does not occur. At the opening longitudinal position P2 in the state D immediately after toner supply, the density matches the target density. However, in the state D immediately after toner supply, gamma characteristics change depending on the longitudinal position of the receiving opening 53b before and after toner supply, so that the density at the non-opening longitudinal positions does not match the target density and thus density unevenness occurs. Also, in the state E after 10 sheets are printed since the toner supply, the change in gamma characteristics depending on the longitudinal position from the state before toner supply remains, so that density unevenness occurs.

In Comparative Example 3, as in Example 1, in the state C before toner supply, the density at each longitudinal position matches the target density, so that density unevenness does not occur. Also, in the state F after 100 sheets are printed since the toner supply, the density at each longitudinal position matches the target density. In both the state C before toner supply and the state F after 100 sheets are printed since the toner supply, although gamma characteristics vary in the longitudinal direction due to differences in the characteristics of the scanner 4, the longitudinal difference in the ratio between new toner and deteriorated toner is absent, so that the longitudinal variation in gamma characteristics is at a similar level in both states. However, in the state D immediately after toner supply, the gamma characteristics change depending on the longitudinal position of the receiving opening 53b before and after toner supply, and the gamma characteristics for each longitudinal position are different from those in the state F in which new toner and degraded toner obtained after 100 sheets are printed since the r toner supply are mixed substantially uniformly in the longitudinal direction. Thus, density unevenness occurs. Also, in the state E after 10 sheets are printed since the toner supply, the change in gamma characteristics depending on the longitudinal position from the state before toner supply remains, so that density unevenness occurs.

In Comparative Example 4, as in Example 1, in the state C before toner supply, gamma correction processing is performed at each longitudinal position to thereby prevent density unevenness in the longitudinal direction from occurring due to the characteristics of the scanner 4.

Thus, in the state C before toner supply, the density at each longitudinal position matches the target density, so that density unevenness does not occur. However, in the state D immediately after toner supply, the gamma characteristics change depending on the longitudinal position of the receiving opening 53b before and after toner supply, so that density unevenness occurs. Further, in Comparative Example 4, the gamma correction characteristics are not varied depending on the longitudinal position, so that density unevenness in the longitudinal direction due to the characteristics of the scanner 4 and density unevenness in the longitudinal direction due to toner supply occur. Compared to Comparative Example 1, a change amount ΔH of gamma correction characteristics having a longitudinal difference in the direction opposite to the longitudinal difference in the amount of change of gamma characteristics from the state before toner supply is used, so that density unevenness has worsened. Also, in the state E after 10 sheets are printed since the toner supply, the change in gamma characteristics depending on the longitudinal position from the state before toner supply remains, so that density unevenness occurs.

In contrast, in Example 1, the density at each longitudinal position matches the target density in all the states C to F, so that the occurrence of density unevenness was successfully prevented.

### Example 2

In control of latent image forming conditions according to Example 2, different latent image forming conditions are used for different print histories of the development unit 50 in an interval (supply interval) between toner supply timings before toner supply, as compared with Example 1. If the development unit 50 has different print histories in the supply interval before toner supply, the degree of deterioration of toner varies and the charge amount of toner varies, so that the manner in which density unevenness occurs before gamma correction processing after toner supply differs. Therefore, in order to appropriately reduce density unevenness, it is necessary to control latent image forming conditions also based on the print history of the development unit 50 in the supply interval. In Example 2, the number of printed sheets J by the development unit 50 in the supply interval before toner supply is used as a print history index. As the print history index, a rotational distance of the development roller 51 accumulated during the image forming operation or the like, a residual toner amount on the development unit 50, and the like that are correlated with the number of printed sheets J can also be used.

When the number of printed sheets J in the supply interval used up to immediately before toner supply is larger, toner in the developing-side accommodating portion 53a is more degraded, so that the change in gamma characteristics before and after toner supply due to mixture of new toner at positions closer to the receiving opening 53b increases. In other words, the change in gamma characteristics before and after toner supply with a larger number of printed sheets J (ΔG2a) is larger than that with a smaller number of printed sheets J (ΔG2b) (ΔG2a>ΔG2b).

On the other hand, such gamma characteristics are obtained in advance by experiments, for example, and gamma correction characteristics calculated from the gamma characteristics for each longitudinal position (recording position L) based on the number of printed sheets J in the supply interval and the number of printed sheets K after toner supply are stored in the ROM 102 and are used for gamma correction processing. Specifically, at the opening longitudinal position P2, the amount of change in gamma correction characteristics that are changed after toner supply from the state C before toner supply is set to have a larger value as the number of printed sheets J in the supply interval increases. In other words, the amount of change in the gamma correction characteristics with a larger number of printed sheets J (ΔH2a) has a greater absolute value than that with a smaller number of printed sheets J (ΔH2b) in the same direction (ΔH2a>ΔH2b). The amount of change in the light emission period of the scanner 4 for pixels having the same halftone level after halftone processing also has a relation similar to that of the amount of change in gamma correction characteristics. As a result of such gamma correction processing, the halftone density at both the non-opening longitudinal position P1 and the opening longitudinal position P2 approaches the target density, regardless of the number of printed sheets J in the supply interval before toner supply, so that density unevenness in the longitudinal direction can be reduced. The halftone density at both the non-opening longitudinal position P3 and the non-opening longitudinal position P4 approaches the target density, so that density unevenness in the longitudinal direction can be reduced.

Thus, the correction amount for gamma correction processing can be appropriately determined for each longitudinal position using the amount of correction depending on the number of printed sheets J in the supply interval before toner supply, in addition to the toner supply timing and the longitudinal position of the receiving opening 53b. Consequently, density unevenness due to toner supply can be appropriately reduced even when the print history of the development unit 50 before toner supply differs.

### Example 3

In Example 3, the above-described luminance correction is controlled to correct the light amount of the scanner 4 as latent image forming conditions to be controlled so as to reduce density unevenness. In Example 3, the luminance correction is performed to change the luminance of the scanner 4 on each pixel, thereby reducing not only density unevenness in a halftone image, but also density unevenness including solid black images.

In step S104 of the control process illustrated in FIG. 12, the control unit 200 obtains information about the correction current to be supplied to the light-emitting unit 401 for each recording position L corresponding to the number of printed sheets K, where the information about the correction current is stored in the ROM 202. The control unit 200 outputs, to the laser driving unit 400, the luminance correction analog voltage 412 corresponding to the information about the correction current to be supplied to the light-emitting unit 401 for each obtained recording position L, thus correcting the luminance of the light-emitting unit 401 of the scanner 4 for each pixel.

The amounts of change in the correction current information, in a direction in which the output density decreases so as to correspond to the direction in which the output density during a state change increases at the longitudinal positions P1 to P4 are defined as correction current change amounts ΔI1 to ΔI4, respectively. The amounts of change in correction current at the longitudinal position P2 in the state D, the state E, and the state F from the state C are defined as ΔI2d, ΔI2e, and ΔI2f, respectively. The correction current change amounts may have negative values. In the following description, the absolute values of the amounts of change in the same direction are compared.

The correction current information that makes the output density match the target density is obtained in advance by experiments, for example, in accordance with the output density change during the state change associated with toner supply described above. The correction current information for each longitudinal position (recording position L) before and after toner supply is stored in the ROM 202 and used for luminance correction. In the luminance correction before and after toner supply, the amount of change in gamma correction characteristics at the opening longitudinal position P2 is set to have a greater absolute value than that at the non-opening longitudinal position P1 in the same direction (ΔI2>ΔI1). In the luminance correction before and after toner supply, the absolute value of the amount of change in correction current information at the non-opening longitudinal position P4 from which the shortest distance to the receiving opening 53b is shorter than the shortest distance from the non-opening longitudinal position P3 is set to be greater than that at the non-opening longitudinal position P3 in the same direction (ΔI4>ΔI3). At the opening longitudinal position P2, the absolute value of the amount of change in correction current information to be changed after toner supply from the state C before toner supply is set to a smaller value in the same direction as the number of printed sheets K advances (ΔI2d>ΔI2e>ΔI2f). The amount of change in the light amount of the scanner 4 on each pixel also has a relation similar to that of the amount of change in correction current information. As a result of such luminance correction, the output density at both the non-opening longitudinal position P1 and the opening longitudinal position P2 approaches the target density, so that density unevenness in the longitudinal direction can be reduced. The output density at both the non-opening longitudinal position P3 and the non-opening longitudinal position P4 approaches the target density, so that density unevenness in the longitudinal direction can be reduced.

A method for correcting the light amount of the scanner 4 so as to obtain advantageous effects of the present embodiment is not limited to the above-described luminance correction method. For example, density correction processing depending on the longitudinal position may be performed on input original image data including a solid black image portion, and image forming processing may be performed based on the image data subjected to the density correction processing. Specifically, the light emission period for pixels including a pixel having a maximum gradation level can be changed as a method of correcting the light amount of the scanner 4, thereby making it possible to reduce density unevenness. Alternatively, a pixel size can be changed as a correction of the light amount of the scanner 4, thereby making it possible to reduce density unevenness.

Thus, the amount of correction for luminance correction can be appropriately determined for each longitudinal position depending on the toner supply timing and the longitudinal position of the receiving opening 53b. Thus, density unevenness due to toner supply can be reduced.

### OTHER EMBODIMENTS

In the above-described embodiments, an example has been described in which a rotary type image forming apparatus is used. Similar advantageous effects can also be obtained for a monochromatic image forming apparatus, an in-line type color image forming apparatus, and the like. In a configuration in which toner is supplied using rotation of a rotary member and gravity of toner, the amount of toner supplied per revolution is small and thus density unevenness is likely to occur. Thus, the effect of reducing density unevenness is significant in such a configuration. Similar advantageous effects can also be obtained for a configuration in which toner is supplied to the development chamber through an opening by a toner conveyance unit, such as a rotatable sheet member.

Similar advantageous effects can also be obtained for a configuration in which toner is supplied to the development chamber through a toner conveyance path that communicates with a discharge opening of the toner cartridge, via an opening that communicates with the toner conveyance path.

In a configuration in which the development chamber is not provided with a toner conveyance unit for conveying toner in the longitudinal direction, such as a screw member, the amount of movement of new toner in the longitudinal direction after toner supply is small and thus density unevenness is more likely to occur. Thus, the effect of reducing density unevenness according to the present embodiment is significant in such a configuration. Similar advantageous effects can also be obtained for a configuration in which the development chamber is provided with a toner conveyance unit for conveying toner in the longitudinal direction.

As described above, control processing according to any of the embodiments can reduce density unevenness due to toner supply.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034133, filed Mar. 4, 2025, which is hereby incorporated by reference herein in its entirety.

What is claimed is:

1. An image forming apparatus comprising:
a photosensitive drum;
an exposure device configured to expose a surface of the photosensitive drum to light to form an electrostatic latent image on the photosensitive drum;
a developing device including:
a development roller configured to supply developer to the electrostatic latent image formed on the photosensitive drum to form a developer image on the photosensitive drum,
a development chamber configured to accommodate the developer to be supplied to the development roller, and
an opening configured to receive the developer to be supplied to the development chamber; and
a correction unit configured to, in a case where the developer is supplied to the development chamber through the opening, correct, for each of a plurality of divided regions into which an image forming region where the developer image is formable is divided in a rotational axis direction of the development roller, a latent image forming condition used by the exposure device to form the electrostatic latent image,
wherein the opening is disposed at a position overlapping the image forming region in the rotational axis direction, and
wherein, with respect to the plurality of divided regions into which the image forming region is divided in the rotational axis direction, when a divided region overlapping the opening in the rotational axis direction is defined as an opening region and a divided region not overlapping the opening in the rotational axis direction is defined as a non-opening region, an amount of change in the latent image forming condition that is corrected for the opening region by the correction unit is larger than an amount of change in the latent image forming condition that is corrected for the non-opening region by the correction unit.

2. The image forming apparatus according to claim 1, wherein, in a case where the developer is supplied to the development chamber after a first image formation, during a second image formation that is next image formation after the first image formation, the correction unit changes, for each divided region, the latent image forming condition as compared with the latent image forming condition during the first image formation.

3. The image forming apparatus according to claim 2, wherein during image formation after the second image formation, as the number of printed sheets since a start of supply of the developer to the development chamber increases, or as a print history index correlated with the number of printed sheets increases, the correction unit decreases an amount of change in the latent image forming condition during an image formation after the second image formation as compared with the latent image forming condition during the first image formation.

4. The image forming apparatus according to claim 1,
wherein the correction unit changes the latent image forming condition at a first position and at a second position in a continuous region of the non-opening region, a shortest distance from the second position to the opening in the rotational axis direction of the development roller being shorter than a shortest distance from the first position to the opening in the rotational axis direction of the development roller, and
wherein, in changing the latent image forming condition at the first position and at the second position, an amount of change in the latent image forming condition at the second position is larger than an amount of change in the latent image forming condition at the first position.

5. The image forming apparatus according to claim 2, wherein the correction unit treats, as one supply interval, a period from a time when supply of the developer to the development chamber is started to a time when supply of the developer to the development chamber is started after the first image formation, and increases an amount of change in the latent image forming condition during image formation after the first image formation as compared with the latent image forming condition during the first image formation as the number of printed sheets in the supply interval increases, or as a print history index correlated with the number of printed sheets in the supply interval increases.

6. The image forming apparatus according to claim 1,
wherein the correction unit changes a light emission period of the exposure device for a pixel, as the latent image forming condition, and
wherein the amount of change in the latent image forming condition is an amount of change in the light emission period.

7. The image forming apparatus according to claim 1,
wherein the correction unit changes, as the latent image forming condition, a luminance of the exposure device for a pixel or a pixel size for the pixel, and
wherein the amount of change in the latent image forming condition is an amount of change in the luminance or in the pixel size.

8. The image forming apparatus according to claim 1, wherein a supply container configured to accommodate the developer and supply the developer to the development chamber is detachably attachable to the developing device, and the supply of the developer to the development chamber is started in response to attachment of the supply container.
